(19) United States
(12) Patent Application Publication
(10) Pub. No.: US 2010/0220346 A1
(43) Pub. Date: Sep. 2, 2010

(54) IMAGE FORMING APPARATUS WITH POWER SUPPLY CONTROLLER

(75) Inventor: SUSUMU HAKAMADA, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/713,698

(22) Filed: Feb. 26, 2010

Related U.S. Application Data
(60) Provisional application No. 61/156,389, filed on Feb. 27, 2009.

(51) Int. Cl. G06F 3/12

(52) U.S. Cl. 358/1.13

(57) ABSTRACT

A power supply method for an image forming apparatus according to the invention includes: calculating a frequency of use of an associated unit that shares a power source with an image forming unit, for each associated unit; setting power supply to the associated unit from the power source to ON-setting or OFF-setting for each associated unit in accordance with the frequency of use; and controlling the power supply to the associated unit for each associated unit in accordance with the ON-setting or the OFF-setting at the time of starting the image forming unit.

### CROSS-REFERENCE TO RELATED APPLICATION

This application is based upon and claims the benefit of priority from Provisional U.S. Application 61/156,389 filed on Feb. 27, 2009, the entire contents of which are incorporated herein by reference.

### TECHNICAL FIELD

The present invention relates to an image forming apparatus having a power supply controller to reduce power consumption in a printer, multi-functional peripheral (MFP) or the like.

### BACKGROUND

There is an image forming apparatus having various optional functions such as a paper discharge unit with a movable tray and a large-capacity cassette. Normally, in the image forming apparatus having optional functions, power is supplied to the entire image forming apparatus including the optional functions until the apparatus enters the ready state after startup. However, generally, the way of using the image forming apparatus varies from user to user. Therefore, in actual image formation, even optional functions that are not used at all may consume startup power and standby power in some cases, and there is a risk that power saving is obstructed.

Thus, it is desired that an image forming apparatus which can efficiently reduce power consumption without impairing user-friendliness in accordance with the way of using the image forming apparatus should be developed.

### SUMMARY

According to an aspect of the invention, wasteful consumption of power is restrained to realize energy saving in a user-friendly image forming apparatus.

According to an embodiment, a power supply method for an image forming apparatus includes: calculating a frequency of use of an associated unit that shares a power source with an image forming unit, for each associated unit; setting power supply to the associated unit from the power source to ON-setting or OFF-setting for each associated unit in accordance with the frequency of use; and controlling the power supply to the associated unit for each associated unit in accordance with the ON-setting or the OFF-setting at the time of starting the image forming unit.

### DESCRIPTION OF THE DRAWINGS

FIG. 1 is a schematic view of configuration showing an MFP according to an embodiment;

FIG. 2 is a schematic view of configuration showing a printer unit, a scanner unit and an ADF unit according to the embodiment;

FIG. 3 is a schematic view of configuration showing the connection between a power source and each unit according to the embodiment;

FIG. 4 is a schematic block diagram showing the control system of the power source according to the embodiment;

FIG. 5 is a flowchart showing procedures to adjust power supplied to each unit from the power source according to the embodiment;

FIG. 6 is a table showing a first total value for each unit during a month in the embodiment; and

FIG. 7 is a flowchart showing printing procedures and update procedures for the adjustment of power.

### DETAILED DESCRIPTION

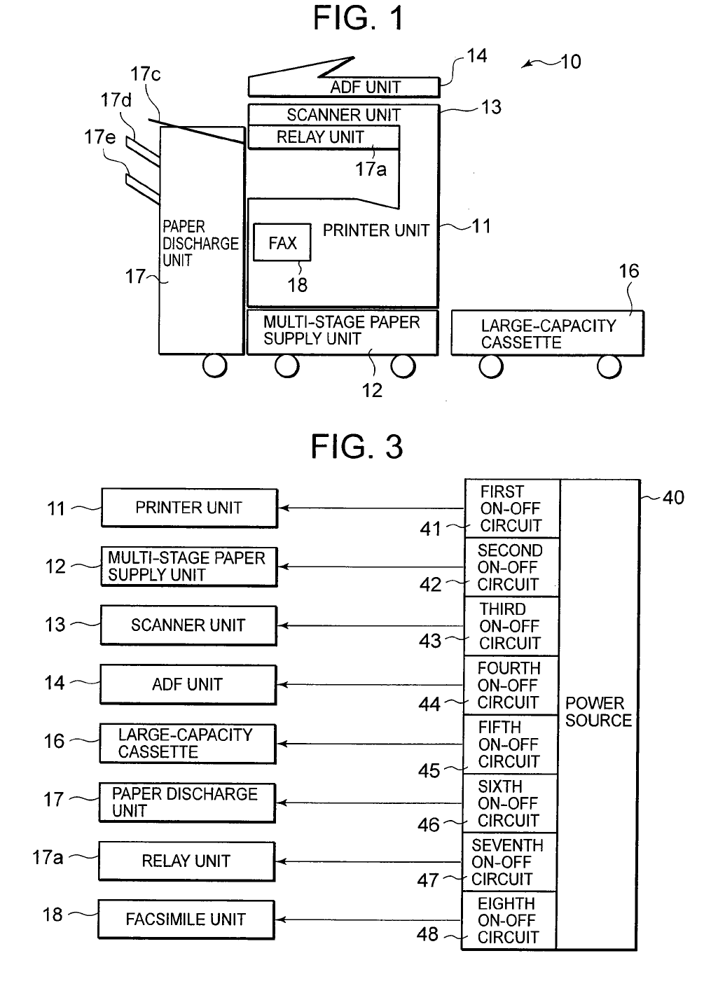

Hereinafter, an embodiment will be described. FIG. 1 is a schematic view of configuration showing a multifunctional peripheral (MFP) 10 as an image forming apparatus according to the embodiment. The MFP 10 has a printer unit 11 as an image forming unit. The MFP 10 has a multi-stage paper supply unit 12 as a paper supply unit which supplies a sheet P as a recording medium to the printer unit 11, a scanner unit 13 which scans an original D, and an automatic document feeder unit (ADF unit) 14 which supplies the original D to the scanner unit 13. The MFP 10 has an optional large-capacity cassette 16 as a paper supply unit which supplies a sheet P to the printer unit 11, an optional paper discharge unit 17 which continuously discharges the sheet P discharged from the printer unit 11, a relay unit 17a, and a facsimile unit 18. Each of the printer unit 11, the multi-stage paper supply unit 12, the scanner unit 13, the ADF unit 14, the large-capacity cassette 16, the paper discharge unit 17 and the facsimile unit 18 is an associated unit.

The MFP 10 has a control panel 15 as an interface with a user. The paper discharge unit 17 bundles sheets P having an image formed thereon by the printer unit 11 and thus discharges the bundled sheets P, or staples and discharges the sheets P for example.

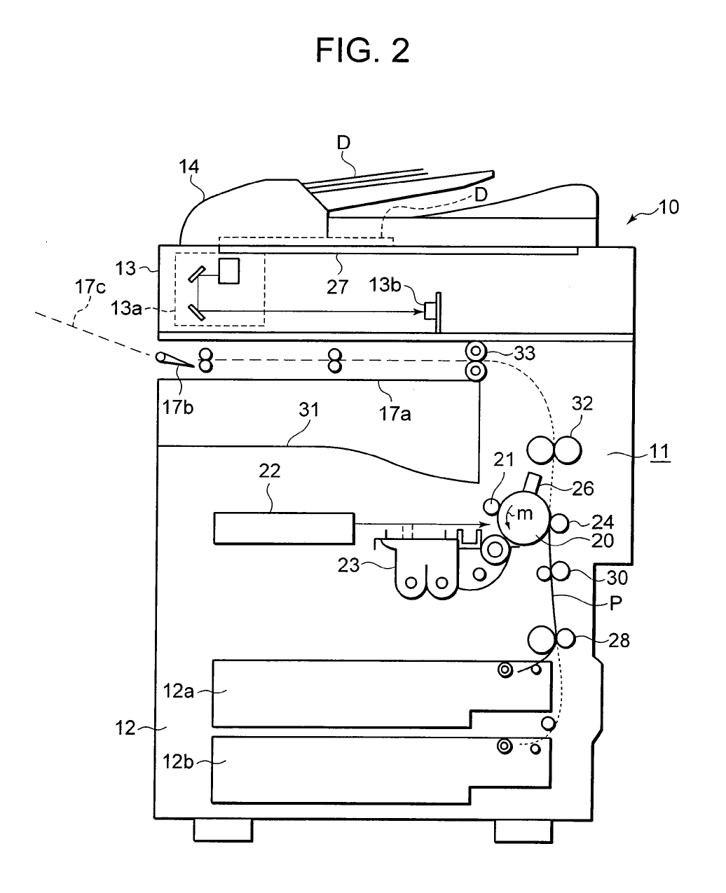

In the MFP 10, an image is formed on the sheet P by the printer unit 11, for example, in accordance with image data on the original D scanned by the scanner unit 13. As shown in FIG. 2, the printer unit 11 has, around a photoconductive drum 20 rotating in the direction of arrow m, for example, a charging roller 21 which uniformly contacts and charges the photoconductive drum 20, an exposure device 22 which exposes the charged photoconductive drum 20 to light and thus forms an electrostatic latent image, a developing device 23 which provides a toner to the electrostatic latent image on the photoconductive drum 20 and thus forms a toner image, a transfer roller 24 which transfers the toner image formed on the photoconductive drum 20 to the sheet P, and a cleaner 26.

The printer unit 11 has a carrying roller 28 and a registration roller 30 between the multi-stage paper supply unit 12 and the photoconductive drum 20. The printer unit 11 has a fixing roller 32 which fixes a toner image by heating and pressurizing, between the photoconductive drum 20 and a paper discharge section 31, and has a paper discharge roller pair 33 which discharges the sheet P after the fixation to the paper discharge section 31 or the paper discharge unit 17.

The scanner unit 13 has an optical mechanism 13a which scans the original D on an original table 27 or the original D supplied by the ADF unit 14, and a charge-coupled device (CCD) 13b which converts an optical signal from the optical mechanism 13a to an electric signal. The multi-stage paper supply unit 12 has first and second paper supply cassettes 12a and 12b.

In the MFP 10, an image is formed on the sheet P by the printer unit 11, for example, in accordance with image data scanned by the scanner unit 13. In the printer unit 11, a toner image corresponding to image data is formed on the photoconductive drum 20. In the printer unit 11, the toner image on the photoconductive drum 20 is transferred by the transfer roller 24, for example, to the sheet P supplied from the multi-stage paper supply unit 12. In the printer unit 11, after the toner image is fixed to the sheet P by the fixing roller 32, the sheet P is discharged from the paper discharge roller pair 33 to the relay unit 17a.

As shown in FIG. 3, a power source 40 distributes and supplies power to the printer unit 11, the multi-stage paper supply unit 12, the scanner unit 13, the ADF unit 14, the large-capacity cassette 16, the paper discharge unit 17, the relay unit 17a and the facsimile unit 18 of the MFP 10 via first to eighth ON-OFF circuits 41 to 48 as switching units. The user sets each of the first to eighth ON-OFF circuits 41 to 48 to ON-setting or OFF-setting, using a touch-panel display unit 15b on the control panel 15 as a setting unit.

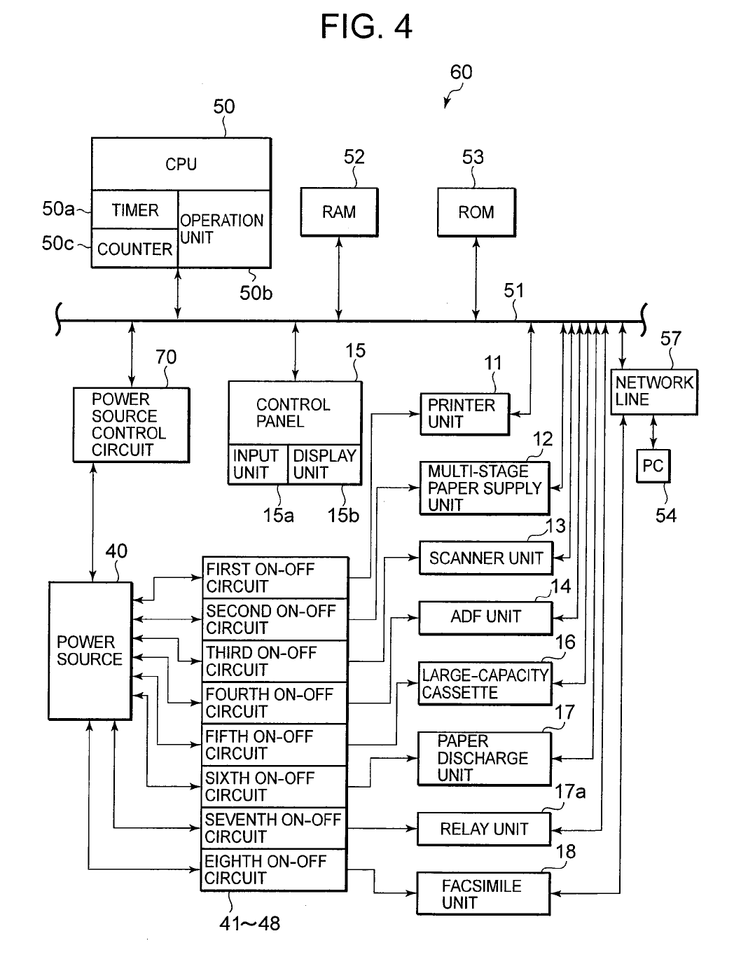

FIG. 4 is a block diagram showing a control system 60 which mainly performs control to supply power to the printer unit 11, the multi-stage paper supply unit 12, the scanner unit 13, the ADF unit 14, the large-capacity cassette 16, the paper discharge unit 17, the relay unit 17a and the facsimile unit 18. A CPU 50 which controls the entirety of the MFP 10 connects to a random access memory (RAM) 52 as a storage unit and a read only memory (ROM) 53 as a storage unit via an input-output (I/O) interface 51. The CPU 50 has a timer 50a, an operation unit 50b and a counter 50c.

In the RAM 52, for example, total values obtained by totaling, for each unit, the numbers of times the multi-stage paper supply unit 12, the scanner unit 13, the ADF unit 14, the large-capacity cassette 16, the paper discharge unit 17, the relay unit 17a and the facsimile unit 18 are used during a predetermined period, are saved. The control panel 15 has the touch-panel display unit 15b which displays various states of the MFP 10 or a user operation screen or the like so that a user's instruction is inputted. The display unit 15b displays the total value for each unit saved in the RAM 52.

The CPU 50 connects to the printer unit 11, the multi-stage paper supply unit 12, the scanner unit 13, the ADF unit 14, the large-capacity cassette 16, the paper discharge unit 17, the relay unit 17a, the control panel 15, and a power supply control circuit 70 as a control unit, via the I/O interface 51. The CPU 50 connects to the facsimile unit 18 and further to a personal computer (PC) 54 via the I/O interface 51 and a network line 57.

The power supply control circuit 70 controls power supply to each of the printer unit 11, the multi-stage paper supply unit 12, the scanner unit 13, the ADF unit 14, the large-capacity cassette 16, the paper discharge unit 17, the relay unit 17a and the facsimile unit 18 from the power source 40 in accordance with the state of the first to eighth ON-OFF circuits 41 to 48.

Even in case the user sets the first to eighth ON-OFF circuits 41 to 48 to OFF, the power source 40 can restore power supply to each unit on predetermined restoration conditions. For example, power supply to the printer unit 11, the multi-stage paper supply unit 12 and the relay unit 17a is restored when the user turns on a copy key of an input unit 15a on the control panel 15 or receives a print or facsimile via the network line 57. Power supply to the large-capacity cassette 16 is restored if the user selects the restoration via the display unit 15b or if there is no sheet of an appropriate print size in the multi-stage paper supply unit 12 when a print or facsimile is received via the network line 57.

Power supply to the scanner unit 13 and the ADF unit 19 is restored when the user turns on the copy key, selects the scan operation via the display unit 15b, or selects transmission of a facsimile via the network line 57. Power supply to the paper discharge unit 17 is restored when the user selects the paper discharge unit 17 via the display unit 15b or when the user selects finishing such as sorting or stapling. Power supply to the facsimile unit 18 is restored when the user selects transmission of a facsimile or when a facsimile is received via the network line 57. The restoration conditions of each unit are not limited to the above.

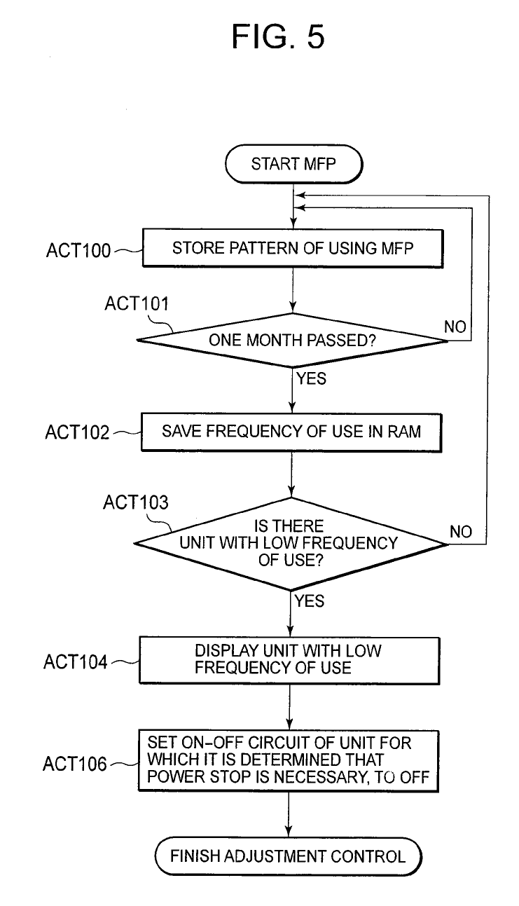

Referring to the flowchart shown in FIG. 5, control to adjust power supply to the printer unit 11, the multi-stage paper supply unit 12, the scanner unit 13, the ADF unit 14, the large-capacity cassette 16, the paper discharge unit 17, the relay unit 17a and the facsimile unit 18 from power source 40 will be described.

When the MFP 10 is installed, the first to eighth ON-OFF circuits 41 to 48 are in an ON-state as the initial state. Therefore, when the MFP 10 is started, the power source 40 supplies power to all of the multi-stage paper supply unit 12, the scanner unit 13, the ADF unit 14, the large-capacity cassette 16, the paper discharge unit 17, the relay unit 17a and the facsimile unit 18. The MFP 10 starts printing when the copy key on the control panel 15 is turned on by the user, when data is inputted from the network line 57 to the facsimile unit 18, or when data is inputted to the CPU 50 by the PC 54 via the network line 57.

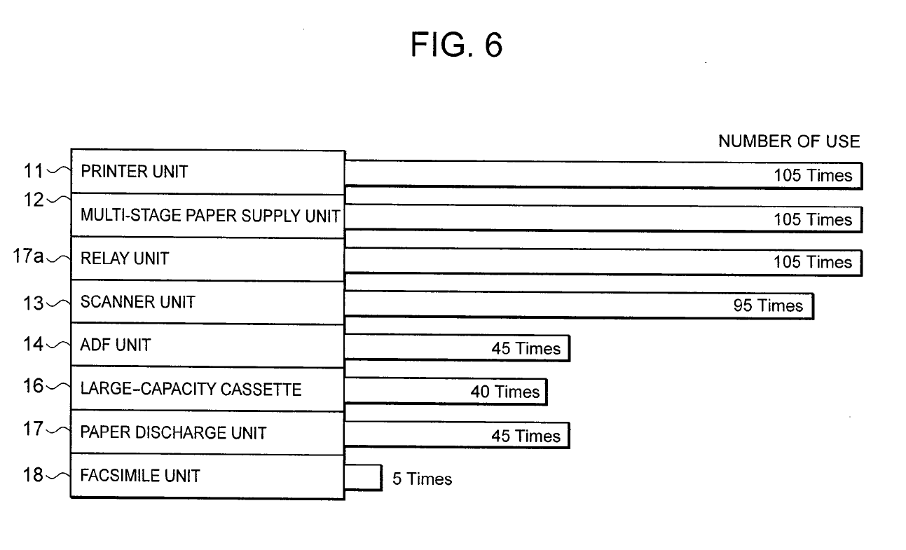

While the MFP 10 is used, the CPU 50 grasps, for example, the method of using or the pattern of using the MFP 10 by the user. The CPU 50 sequentially accumulates the number of times each of the printer unit 11, the multi-stage paper supply unit 12, the scanner unit 13, the ADF unit 14, the large-capacity cassette 16, the paper discharge unit 17, the relay unit 17a and the facsimile unit 18 is used, and saves the total value in the RAM 52 for interim period (ACT 100). The CPU 50 calculates, as a first total value, a first number of times of use of each unit, for example, during a month as a first predetermined period. After a month passes (Yes in ACT 101), the CPU 50 saves the first total value for each unit in the RAM 52 (ACT 102). The RAM 52 saves a graph shown in FIG. 6 as the first total value for each unit.

Next, the operation unit 50b of the CPU 50 searches the graph to find out whether there is a unit with a lower number of use times compared to the number of times the printer unit 11 is driven and calculates a frequency of use (ACT 103). For example, when the frequency of use is equal to or less than 50% of the number of times the printer unit 11 is driven, it is determined that the unit is a unit with a low frequency of use. The CPU 50 notifies the user by displaying the unit with a low frequency of use in the display unit 15b of the control panel 15 (ACT 104). In the display unit 15b, for example, the name of the unit and its frequency of use in percentage are displayed. On the basis of the graph, the frequency of use 8.6% for the ADF unit 14 and the paper discharge unit 17, the frequency of use 7.6% for the large-capacity cassette 16, and the frequency of use 4.8% for the facsimile unit 18 are displayed in the display unit 15b.

In accordance with the display in the display unit 15b, the user sets to OFF the ON-OFF circuit of a unit for which it is determined that power stop is necessary (ACT 106). For example the user determines that power of the paper discharge unit 17 and the facsimile unit 18 needs to be stopped with reference to the display in the display unit 15b, the user sets the sixth ON-OFF circuit 46 and the eighth ON-OFF circuit 48 to OFF, and then finishes the control to adjust power supply to the printer unit 11, the multi-stage paper supply unit 12, the scanner unit 13, the ADF unit 14, the large-capacity cassette 16, the paper discharge unit 17, the relay unit 17a and the facsimile unit 18 from the power source 40.

When the MFP 10 is restarted after the sixth ON-OFF circuit 46 and the eighth ON-OFF circuit 48 are set to OFF, the power supply control circuit 70 controls the power source 40 so that power is supplied from the power source 40 to the printer unit 11, the multi-stage paper supply unit 12, the scanner unit 13, the ADF unit 14, the large-capacity cassette 16 and the relay unit 17a, whereas power supply to the paper discharge unit 17 and the facsimile unit 18 from the power source 40 is stopped. When power supply to the paper discharge unit 17 is stopped, a paper discharge gate 17b of the paper discharge unit 17 is branched into the direction of a fixed tray 17c of the paper discharge unit 17. Also, the display unit 15b shows that power supply to the paper discharge unit 17 and the facsimile unit 18 is stopped, thus notifying the user.

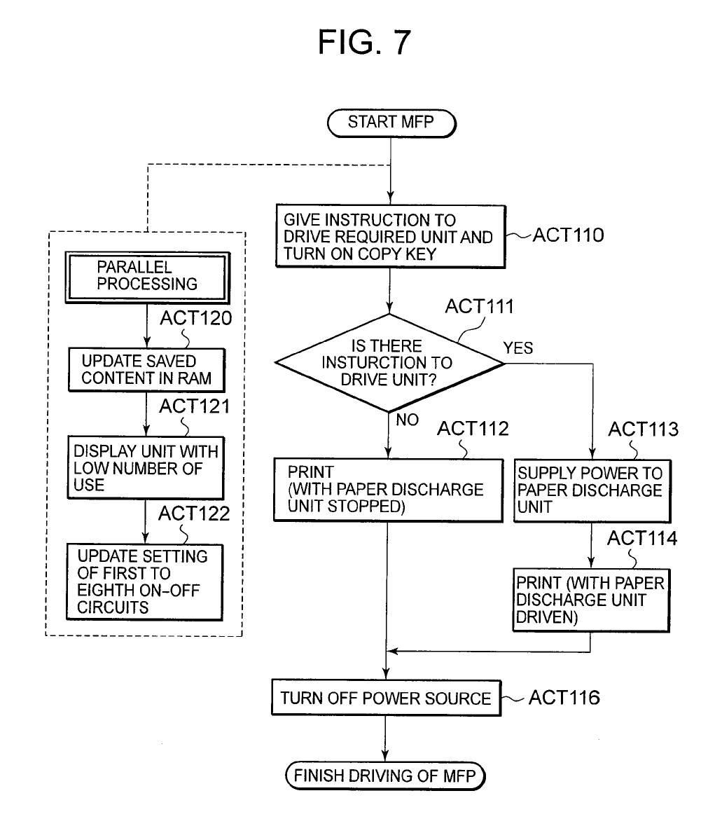

Next, with reference to the flowchart shown in FIG. 7, printing procedures by the MFP 10 after adjusting power supply to each unit and update procedures for the adjustment of power supply to each unit will be described. When the MFP 10 is started after the user sets the sixth ON-OFF circuit 46 and the eighth ON-OFF circuit 48 to OFF in ACT 106, the CPU 50 controls the power supply control circuit 70 so that power is supplied to the printer unit 11, the multi-stage paper supply unit 12, the scanner unit 13, the ADF unit 14, the large-capacity cassette 16 and the relay unit 17a, excluding the paper discharge unit 17 and the facsimile unit 18, in accordance with the user's setting in ACT 106. At the time of printing, the user confirms the status of power supply to each unit, in the display unit 15b. In case a unit that is currently stopped needs to be driven, the user gives an instruction to drive the unit that needs driving, of the stopped units, via the display unit 15b. For example, the user turns on the copy key to start printing (ACT 110).

In case there is no instruction to drive a unit from the user (No in ACT 111), the MFP 10 carries out printing in the state where the paper discharge unit 17 is stopped (ACT 112). Therefore, the MFP 10 discharges the sheet P on which printing is finished to the fixed tray 17c via the printer unit 11 and the relay unit 17a. In case the user gives an instruction to drive a unit (Yes in ACT 111), the CPU 50 controls power supply control circuit 70 so that power is supplied to the unit designated by the user. For example, in case the user gives an instruction to drive the paper discharge unit 17, the CPU 50 sets the sixth ON-OFF circuit 46 to ON-setting and the power supply control circuit 70 supplies power to the paper discharge unit 17 (ACT 113). The MFP 10 carries out printing in the state where the paper discharge unit 17 is driven (ACT 114). At this time, the CPU 50 branches the paper discharge gate 17b of the relay unit 17a into the processing direction of the paper discharge unit 17. Therefore, the MFP 10 carries the sheet P on which printing is finished in the processing direction of the paper discharge unit 17 from the relay unit 17a and carries out finishing such as stapling. After that, the MFP 10 discharges the sheet P in the direction of a paper discharge tray 17d or a paper discharge tray 17e. When predetermined printing is finished, the power source 40 is turned off (ACT 116). Then, driving of the MFP 10 is finished.

When the MFP 10 is restarted after that, even if there is an instruction to start the paper discharge unit 17 in the previous startup, the CPU 50 controls the power supply control circuit 70 so that power is not supplied to the paper discharge unit 17 and the facsimile unit 18, whereas power is supplied to the printer unit 11, the multi-stage paper supply unit 12, the scanner unit 13, the ADF unit 14, the large-capacity cassette 16 and the relay unit 17a in accordance with the user's setting in ACT 106.

In parallel with the above, the user properly updates the setting of the first to eighth ON-OFF circuits 41 to 48 in accordance with the pattern of using the MFP 10. For example, the CPU 50 replaces the first total value saved in the RAM 52 with a second total value which calculates a second number of times of use of each unit of the MFP 10 during a second predetermined period (for example, a month) after the lapse of the first predetermined period to save the second total value in the RAM 52, and thus updates the saved content in the RAM 52 (ACT 120). The operation unit 50b of the CPU 50 searches for a unit with a low number of times of use on the basis of the second total value in the RAM 52 that is updated and calculates the frequency of use then updates the frequency of use. The CPU 50 displays the result of the search in the display unit 15b and thus notifies the user (ACT 121). The user updates the setting of the first to eighth ON-OFF circuits 41 to 48 in accordance with the display in the display unit 15b (ACT 122). The user, for example, updates the sixth ON-OFF circuit 46 to ON-setting and updates the fourth ON-OFF circuit 44 to OFF-setting with reference to the display in the display unit 15b.

Thus, the next time the MFP 10 is started, the CPU 50 controls the power supply control circuit 70 so that power is not supplied to the ADF unit 14, whereas power is supplied to the print unit 11, the multi-stage paper supply unit 12, the scanner unit 13, the large-capacity cassette 16, the paper discharge unit 17, the relay unit 17a and the facsimile unit 18 in accordance with the user's setting in ACT 122. After that, the CPU 50 repeats operation which replacing the first total value saved in the RAM 52 with the second total value, and in accordance with the way of using the MFP 10, stops the power supply for a unit for which the user determines that power supply should be stopped.

After that, until the next time the user updates the setting of the first to eighth ON-OFF circuits 41 to 48, when the MFP 10 is started, the CPU 50 controls the power supply control circuit 70 so that power is supplied to the print unit 11, the multi-stage paper supply unit 12, the scanner unit 13, the large-capacity cassette 16, the paper discharge unit 17, the relay unit 17a and the facsimile unit 18 excluding the ADF unit 14, in accordance with the user's setting in ACT 122. During this time, in case the ADF unit 14, which is stopped, needs to be driven, the user gives an instruction to drive the ADF unit 14 via the display unit 15b. The instruction to drive the ADF unit 14 may also be given by setting the original D in the ADF unit 14.

In this embodiment, in accordance with the way of using the MFP 10, power supply at the time of starting the MFP 10 or during the subsequent driving is stopped for a unit for which the user determines that power supply should be stopped. When necessary, the user gives an instruction to supply power to the unit for which power supply is stopped. Therefore, consumption of startup power and standby power of a unit with a low frequency of use can be restrained and further energy-saving of the MFP 10 can be realized without impairing user-friendliness.

The invention is not limited to the above embodiment and various changes and modifications can be made without departing from the scope of the invention. For example, the type, shape and so on of the units constituting the image forming apparatus may be arbitrary and the printer unit may be a color printer or the like. Also, the predetermined period for which the user sets units to ON-setting or OFF-setting and then updates the setting is not limited and can be arbitrarily set such as one week.

What is claimed is:

1. A power supply method for an image forming apparatus comprising:
calculating a frequency of use of an associated unit that shares a power source with an image forming unit, for each associated unit;
setting power supply to the associated unit from the power source to ON-setting or OFF-setting for each associated unit in accordance with the frequency of use; and
controlling the power supply to the associated unit for each associated unit in accordance with the ON-setting or the OFF-setting at the time of starting the image forming unit.

2. The method of claim 1, wherein the frequency is calculated from a first total value as a result of totaling a first number of times of use of the associated unit for each associated unit during a first predetermined period.

3. The method of claim 2, wherein the first total value is replaced with a second total value as a result of totaling a second number of times of use the associated unit for each associated unit during a second predetermined period after the lapse of the first predetermined period, and the frequency of use is updated.

4. The method of claim 3, wherein the ON-setting or the OFF-setting for each associated unit with respect to power supply to the associated unit from the power source is updated in accordance with the updated frequency of use.

5. The method of claim 1, wherein when there is an instruction to drive the associated unit with the OFF-setting, power is supplied to the associated unit for which the instruction to drive is given.

6. The method of claim 5, wherein when the image forming unit is restarted, the associated unit for which the instruction to drive is given is controlled in accordance with the OFF-setting.

7. A power supply method for an image forming apparatus comprising:
calculating a frequency of use of an associated unit that shares a power source with an image forming unit, for each associated unit;
updating the frequency of use;
setting power supply to the associated unit from the power source to ON-setting or OFF-setting for each associated unit in accordance with the latest frequency of use;
controlling the power supply to the associated unit for each associated unit in accordance with the ON-setting or the OFF-setting every time the image forming unit is started; and
supplying power to the associated unit for which the instruction to drive is given while the image forming unit is continuously driven, when there is an instruction to drive the associated unit with the OFF-setting.

8. The method of claim 7, wherein the frequency is calculated from a first total value as a result of totaling a first number of times of use of the associated unit for each associated unit during a first predetermined period.

9. The method of claim 8, wherein the first total value is replaced with a second total value as a result of totaling a second number of times of use of the associated unit for each associated unit during a second predetermined period after the lapse of the first predetermined period, and the frequency of use is updated.

10. An image forming apparatus comprising:
an image forming unit;
an associated unit;
a power source which supplies power to the image forming unit and the associated unit;
plural switching units which switch between the image forming unit and the associated unit, and the power source for each;
a storage unit which saves a number of times of use of the associated unit for each associated unit;
a setting unit which sets the plural switching units for each to ON-setting or OFF-setting; and
a control unit which controls, for each associated unit for each, the power supply to the associated unit in accordance with the ON-setting or the OFF-setting of the switching units set by the setting unit when the image forming unit is started.

11. The apparatus of claim 10, wherein when there is an instruction to drive the associated unit for which the setting unit sets the switching units to the OFF-setting, the control unit supplies power to the associated unit for which the instruction to drive is given.

12. The apparatus of claim 11, wherein when the image forming unit is restarted, the control unit controls the associated unit for which the instruction to drive is given in accordance with the setting by the setting unit.

13. The apparatus of claim 10, wherein the storage unit stores a first total value as a result of totaling a first number of times of use of the associated unit for each associated unit during a first predetermined period.

14. The apparatus of claim 13, wherein the storage unit replaces the first total value with a second total value as a result of totaling a second number of times of use of the associated unit for each associated unit during a second predetermined period after the lapse of the first predetermined period.

15. The apparatus of claim 10, wherein the associated unit has at least one of a paper supply unit which supplies a recording medium to the image forming unit, a scanner unit which scans an image of an original, an automatic document feeder unit which supplies the original to the scanner unit, a paper discharge unit which continuously discharges the recording medium discharged from the image forming unit, and a facsimile unit.

16. The apparatus of claim 15, wherein when there is an instruction to drive the associated unit for which the setting unit sets the switching units to the OFF-setting, the control unit supplies power to the associated unit for which the instruction to drive is given.

17. The apparatus of claim 16, wherein when the image forming unit is restarted, the control unit controls the associated unit for which the instruction to drive is given in accordance with the setting by the setting unit.

18. The apparatus of claim 15, wherein the storage unit stores a first total value as a result of totaling a first number of times of use of the associated unit for each associated unit during a first predetermined period.

19. The apparatus of claim 18, wherein the storage unit replaces the first total value with a second total value as a result of totaling a second number of times of use of the associated unit for each associated unit during a second predetermined period after the lapse of the first predetermined period.
